(19) United States
(12) Patent Application Publication
(10) Pub. No.: US 2020/0131847 A1
(43) Pub. Date: Apr. 30, 2020

(54) SPOOL BOX FOR MANUAL TO MOTORIZED WINDOW COVERING

(71) Applicant: TECHTRONIC CORDLESS GP, Anderson, SC (US)

(72) Inventor: Austin Clark, Seneca, SC (US)

(73) Assignee: TECHTRONIC CORDLESS GP

(21) Appl. No.: 16/655,568

(22) Filed: Oct. 17, 2019

Related U.S. Application Data
(60) Provisional application No. 62/750,631, filed on Oct. 25, 2018.

(51) Int. Cl. E06B 9/322; E06B 9/74

(52) U.S. Cl. CPC E06B 9/322; E06B 2009/2627; E06B 9/74

(57) ABSTRACT

A spool box is configured to permit a change in the operation of a window covering from a manually-operated stated to a motorized state. The spool box may include a transfer drum, a coil spring drum, and a cord spool, together which permit the manual raising and lowering of the window covering. The spool box also may include an interface for coupling with a motorized converter module. When the spool box and motorized converter module are coupled, the window covering may be raised and lowered by a motorized operation.

This application claims the benefit of U.S. Provisional Application No. 62/750,631, filed Oct. 25, 2018, the contents of which are hereby incorporated by reference in their entirety.

### TECHNICAL FIELD

The present subject matter relates to a window covering assembly, in particular a window covering assembly that may be operated manually or by a motor.

### BACKGROUND

A window covering, such as blinds (e.g., cellular blinds), may cover all or a portion of one or more windows. Periodically, it is desired for the window covering to cover more or less of the window. In such instances, the window covering may be operated manually. For example, in the case of cellular blinds, a force may be applied to the bottom of the cellular blinds to raise or lower them. Alternatively, the window covering may be operated by a motor. For example, also in the case of cellular blinds, a motor may drive a spool to either take in or let out a cord attached to the bottom of the cellular blinds to raise or lower them. However, there is not a window covering assembly that may be readily converted from a state in which it is operated manually to a state in which it is operated by a motor and vice versa.

### SUMMARY

The present subject matter relates to a spool box of a window covering assembly that has components that are configured to permit a window covering to be operated manually or by a motor and to facilitate the conversion of the window covering assembly between a manually-operated state and a motorized state and associated methods of facilitating the conversion. More particularly, the spool box is configured to permit the manual raising and lowering of the window covering. In one embodiment, the spool box includes a spool around which a cord, which is attached to the window covering, is disposed. The spool box may include a spring that, upon being energized as a result of movement of the window covering, assists in the movement of the window covering in a return direction. The spool box includes a component that is configured to connect to a motorized module. Upon connection of the spool box and the motorized module, the window covering may be raised and lowered by the motorized module. The motorized module may be that described in U.S. Patent Application No. 62/683,297, entitled “Manual to Motorized Cellular Blinds Converter Module,” filed on Jun. 11, 2018, and/or U.S. patent application Ser. No. 16/356,763, entitled “Devices and Methods for Manual to Motorized Convertible Window Assemblies,” filed on Mar. 18, 2019. The disclosures of the two aforementioned applications are incorporated by reference herein. In one embodiment, the spool box is configured such that the component that connects to the motorized module is accessible without the need to remove any of the components of the spool box. Thus, conversion from a manual state to a motorized state may be readily accomplished. The window covering may be blinds (e.g., cellular blinds).

### BRIEF DESCRIPTION OF THE DRAWINGS

FIG. 1 is a top view of a spool box, with a portion of its housing not shown, according to one embodiment of the present subject matter.

FIG. 2 is a top view of an assembly of a motorized converter module, with a portion of its housing not shown, connected to a spool box, with a portion of its housing not shown, according to one embodiment of the present subject matter.

FIG. 3 is a perspective view of a spool box according to one embodiment of the present subject matter.

FIG. 4 is a perspective view of a transfer drum according to one embodiment of the present subject matter.

FIG. 5 is a perspective view of a motorized converter module that is configured to connect to a spool box according to one embodiment of the present subject matter.

FIG. 6 is a perspective view of a transfer drum according to an alternative embodiment of the present subject matter.

FIG. 7 is a partial side view of a spool box, with a portion of its housing not shown, according to an alternative embodiment of the present subject matter.

### DETAILED DESCRIPTION

Reference will now be made in detail to the preferred embodiments of the present subject matter, which are illustrated in the accompanying drawings.

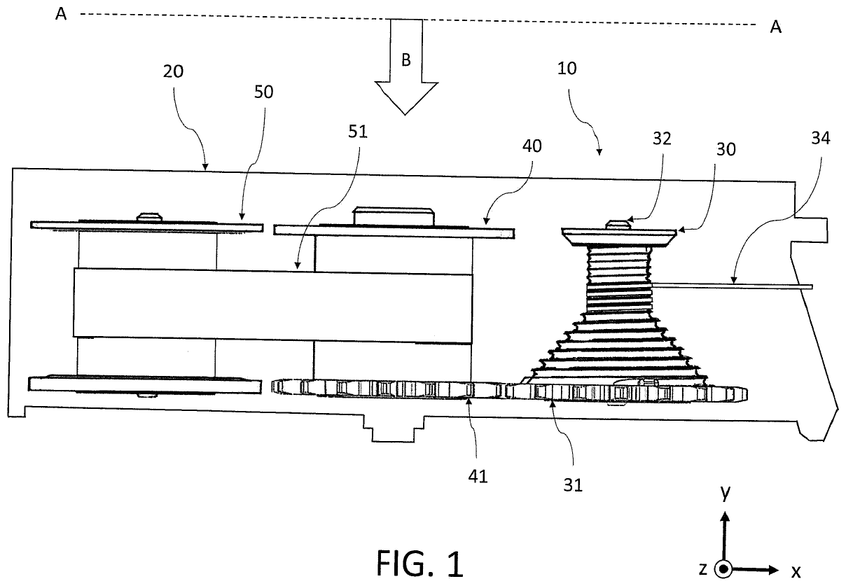

FIG. 1 shows a spool box 10 according to one embodiment of the present subject matter. In FIG. 1, a portion of a housing of spool box 10 is not shown so as to reveal certain internal components. Spool box 10 may be disposed in a window covering header (not shown), to which a window covering (not shown) is suspended. The window covering may include blinds (e.g., cellular blinds). The spool box 10 may include a housing 20, in which may be disposed a cord spool 30, a transfer drum 40, and a coil spring drum 50. One end of a cord 34 may be wound around cord spool 30, and the other end of cord 34 may be attached to the window covering.

As described in greater detail below, spool box 10 is configured to facilitate the manual raising or lowering of the window covering by either an upward or downward force applied to the window covering. In the manual operation, the cord spool 30 may take up (when the window covering is raised) or let out (when the window covering is lowered) a portion of the cord 34. The manual lowering of the window covering also may cause a coil spring 51, which is attached to coil spring drum 50, to become energized. The energized coil spring 51 may assist in the manual raising of the window covering.

Also as described in greater detail below, spool box 10 is configured to facilitate the motorized raising or lowering of the window covering when the motor applies a torque to a component of the spool box 10. For example, the transfer drum 40 may include an interface that receives torque generated by a motor. The torque may cause transfer drum 40 to rotate in either of two angular directions, which may cause rotation of cord spool 30 and thereby the taking up (when the window covering is raised) or letting out (when the window covering is lowered) of a portion of the cord 34. In the case of the lowering of the window covering, rotation of transfer drum 40 also may cause the energizing of coil spring 51, similar to the manual operation.

Cord spool 30 may include a spur gear 31 at one end. Cord spool 30 may be provided with a shaft 32 around which the cord spool 30 rotates. Shaft 32 may be fixedly attached to housing 20.

Transfer drum 40 may be provided with a spur gear 41 on one end. In one embodiment, cord spool 30 and transfer drum 40 may be arranged such that spur gear 31 and spur gear 41 engage (e.g., mesh) with each other.

Coil spring drum 50 may be disposed on a side of the transfer drum 40 opposite that on which the cord spool 30 is disposed. One end of coil spring 51 may be attached to and/or wound around coil spring drum 50. The other end of coil spring 51 may be attached to and/or wound around transfer drum 40.

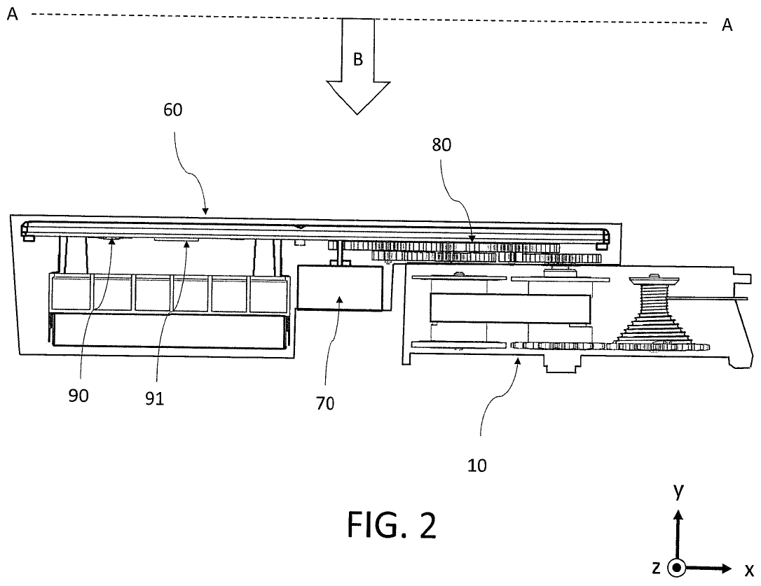

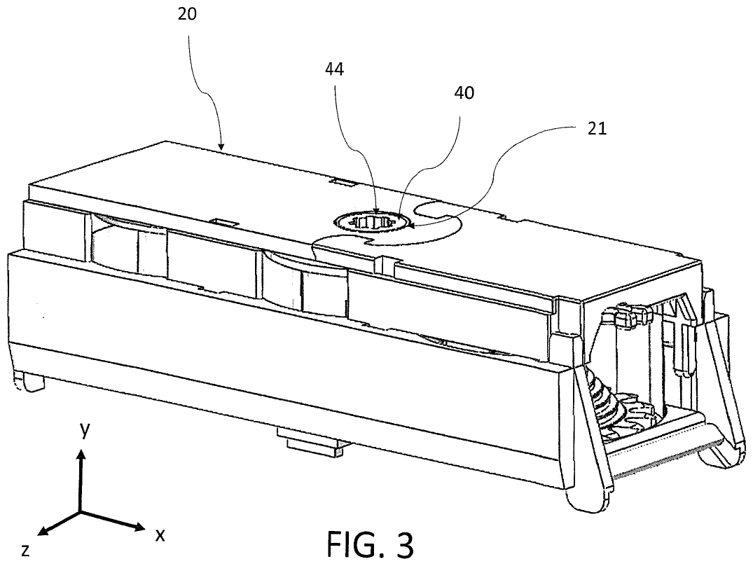

Manual operation of the window covering will now be described with reference to the figures. In FIGS. 1-3, coordinate axes, reference plane A-A, and direction B are provided to aide in this description. The coordinate axes are right-handed coordinates so that, in FIGS. 1 and 2, the z-axis is directed out of the page and, in FIG. 3, the x-axis, y-axis, and z-axis are directed both partially along the page and partially out of the page. A window covering, for example cellular blinds, may be raised or lowered by direct manual manipulation (e.g., pulling, pushing, and/or the like) of the window covering and/or portions thereof. For example, if the window covering is in a raised position, the window covering may be lowered by way of applying a force that pulls down (i.e., in the −z direction) on the window covering. When such a force is applied, cord 34 may unwind (in the +x direction) from cord spool 30, which may cause cord spool 30 to rotate on shaft 32 (in a clockwise direction along an axis in the y direction, as viewed from plane A-A in the −y direction, i.e., as indicated by arrow B). This may cause rotation (in a clockwise direction, as viewed in the direction of arrow B) of spur gear 31 (i.e., spur gear 31 may also be referred to as a first spur gear), which in turn may cause a rotation (in a counter-clockwise direction, as viewed in the direction of arrow B) of spur gear 41 (i.e., spur gear 41 may also be referred to as a second spur gear). Because drum 40 is attached to spur gear 41, rotation of spur gear 41 causes rotation of transfer drum 40 (in a counter-clockwise direction, as viewed in the direction of arrow B). When transfer drum 40 rotates, it may cause the unwinding and energizing of coil spring 51 from coil spring drum 50. In an energized state, coil spring 51 may exert a torque on transfer drum 40 in a direction opposite that in which transfer drum 40 rotates during the foregoing operation (i.e., coil spring 51 may exert a torque on transfer drum 40 in the clockwise direction, as viewed in the direction of arrow B). However, the torque exerted by coil spring 51 may not be large enough to overcome the torque imparted on transfer drum 40 by the weight of the window covering. In particular, the weight of the window covering may pull on cord 34, thereby imparting a torque on cord spool 30, which, by way of spur gears 31 and 41, exerts a torque on transfer drum 40. The torque that is exerted by coil spring 51 on transfer drum 40 may reduce the force required to raise the window covering, as explained below.

The window covering may be manually raised by way of applying a force that pushes up (in the +z direction) on the window covering. This may reduce the torque imparted on transfer drum 40 by the weight of the window covering. When the force imparted to the window covering is sufficiently great, the torque imparted by coil spring 51 may be greater than the torque (in an opposite direction) imparted by the weight of the window covering (reduced by the upward force). Thus, transfer drum 40 may rotate (in a clockwise direction, as viewed in the direction of arrow B). Due to the interaction of spur gears 31 and 41, cord spool 30 may rotate around shaft 32 (in a counter-clockwise direction, as viewed in the direction of arrow B), thereby taking in a portion of cord 34 and causing a portion of cord 34 to become wound around cord spool 30. The rotation of transfer drum 40 also may cause the winding of coil spring 51 around coil spring drum 50, i.e., towards a non-energized state, thereby reducing the force exerted by the coil spring 51.

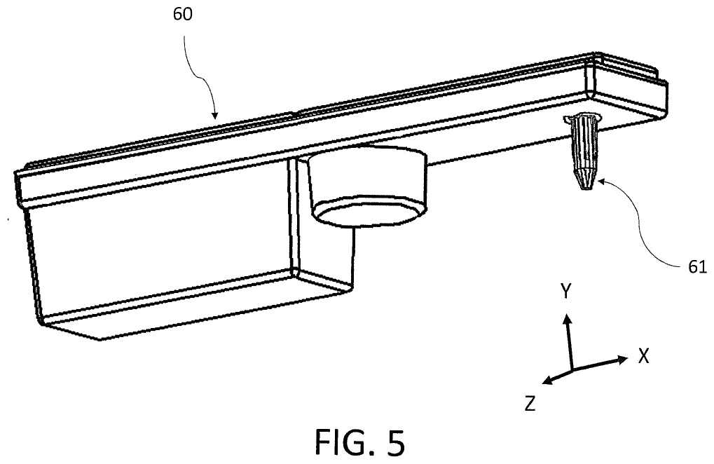

FIG. 2 is a top view of an assembly of a motorized converter module 60 coupled to spool box 10. The motorized converter module 60 may permit the motorized raising or lowering of window covering by transferring a torque created by motor 70 to one or more of the components of the spool box 10, for example the transfer drum 40, sufficient to cause a portion of cord 34 to become taken up by or let out from cord spool 30. In FIG. 2, portions of the respective housings of the motorized converter module 60 and the spool box 10 are not shown so as to reveal certain internal components. The motorized converter module 60 may correspond to the module described in U.S. Patent Application No. 62/683,297, entitled “Manual to Motorized Cellular Blinds Converter Module,” filed on Jun. 11, 2018 and/or U.S. patent application Ser. No. 16/356,763, entitled “Devices and Methods for Manual to Motorized Convertible Window Assemblies,” filed on Mar. 18, 2019. The motorized converter module 60 may include a shaft 61 (shown in FIG. 5). As shown in FIG. 5, in one embodiment, shaft 61 is generally cylindrical with an external spline. The present subject matter is not limited in this regard however, and the shaft 61 may have other cross-sectional geometries, including a hexagonal cross-section, a triangular cross-section, and/or the like. The spool box 10 may include a component that has a similarly-shaped, and slightly larger hole for receiving and interfacing with shaft 61. The motorized converter module 60 is configured to couple or attach to the spool box 10 without the need to remove any parts of the spool box 10 or otherwise make any significant alterations to the spool box 10 or the window covering header.

Motorized operation of the window covering will now be described. After the motorized converter module 60 is coupled to spool box 10, the window covering may be raised or lowered by activating a motor 70 of the motorized converter module 60. For example, the window covering may be lowered by activating the motor 70 in a first direction (i.e., counter-clockwise when viewed in the direction of arrow B). The motor 70 may cause, via a transmission 80, rotation of shaft 61. In one embodiment, the transmission 80 includes a pinion attached to a shaft of the motor 70 and an even number of spur gears comprising a gear train, and the shaft 61 is connected to the last gear in the train. Thus, activating the motor 70 in the first direction will cause rotation of shaft 61 in the same direction. In some embodiments, the motor 70 causes rotation of shaft 61 based on commands communicated via a circuit board and/or components disposed on a circuit board connected to the motor. In some embodiments, a processor component 90, such as a microcontroller, a digital signal processor (DSP), a system on a chip (SoC), an integrated circuit (IC), control circuitry, and/or the like, is configured to control the motor for inducing or causing the rotation of shaft 61. Such control may be implemented by way of the processor component reading and executing software instructions stored in a memory component 91 (e.g., a non-transitory memory device such as a RAM, a ROM, a flash memory, an optical memory, and/or the like), which is in electrical communication with the processor component of the motor. When executed, the software instructions stored in the memory component may cause the processor component to perform one or more processes described herein. Additionally, or alternatively, hardwired circuitry may be used in place of or in combination with software instructions to perform one or more processes described herein. Thus, the embodiments described herein are not limited to any specific combination of hardware circuitry and software.

Returning to the operation of the motorized converter module 60, the shaft 61 may attach to and/or otherwise transfer torque to transfer drum 40, such that transfer drum 40 rotates in the first direction (i.e., in a counter-clockwise direction, when viewed in the direction of arrow B). By way of spur gears 41 and 31, this rotation causes cord spool 30 to rotate in the clockwise direction (as viewed in the direction of arrow B), which causes the letting out of a portion of cord 34 and thus the lowering of the window covering. As with the exemplary embodiment discussed above, when the motorized converter module 60 is coupled to the spool box 10, the window covering may be cellular blinds. Rotation of transfer drum 40 in the counter-clockwise direction (as viewed in the direction of arrow B) also may cause part of coil spring 51 to become unwound from coil spring drum 50 and a part of coil spring 51 to become wound onto transfer drum 40. As with the embodiment described above, this may energize coil spring 51 such that coil spring 51 may exert a torque on transfer drum 40, but not enough to overcome the torque caused by the weight of the window covering.

The window covering may be raised by activating the motor 70 of the motorized converter module 60 in a second direction (i.e., in a clockwise direction, as viewed in the direction of arrow B). This may cause, via the transmission 80, rotation of shaft 61 in the second direction. The shaft 61 may transfer torque to transfer drum 40, such that transfer drum 40 rotates in a clockwise direction (as viewed in the direction of arrow B). The torque imparted by coil spring 51 may assist in the rotation of transfer drum 40. As transfer drum 40 rotates, it may cause, via the interaction of gears 31 and 41, cord spool 30 to rotate about shaft 32 (in a counter-clockwise direction, as viewed in the direction of arrow B) and take up cord 34 (see FIG. 1). This raises the window covering to which cord 34 is attached.

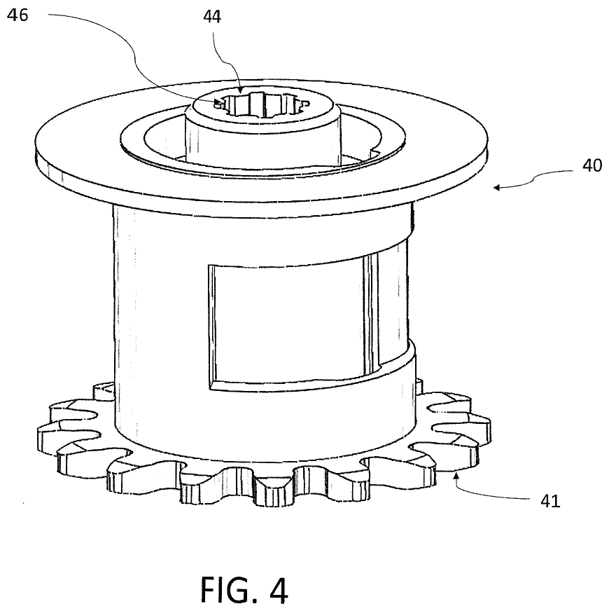

FIG. 3 shows the features of the spool box 10 that may permit coupling with the motorized converter module 60. As shown in FIG. 3, the housing 20 may be provided with a coupler opening 21. Through coupler opening 21, transfer drum 40 may be accessible from the outside. As shown in FIGS. 3 and 4, at the top of transfer drum 40, an interface 44 is provided for reception of the shaft 61. As shown in FIG. 4, in one embodiment, to accommodate shaft 61, the interface 44 of transfer drum 40 may include an internal spline 46. In another embodiment, interface 44 has a hexagonal cross-section for reception of a shaft 61 with a hexagonal cross-section.

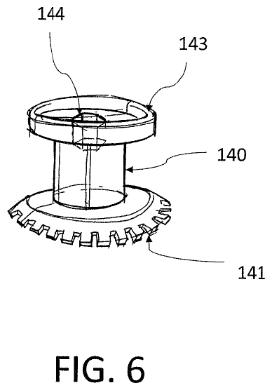

FIG. 6 shows a transfer drum 140 according to an alternative embodiment of the present subject matter. As shown in FIG. 6, the transfer drum 140 may include a spur gear 141 as well as an interface 144. The transfer drum 140 also may include ridge 143 extending circumferentially around transfer drum 140.

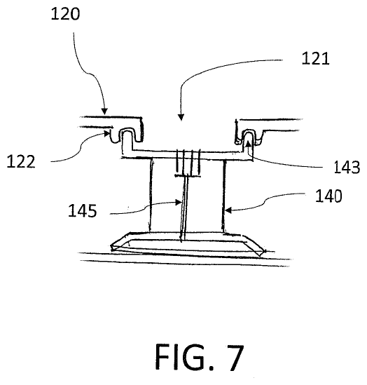

FIG. 7 shows a partial side view of a spool box according to an alternative embodiment, in particular an embodiment that includes transfer drum 140. In FIG. 7, a portion of the housing 120 of the spool box is not shown so as to reveal certain internal components. Shown in FIG. 7 are a portion of housing 120 and transfer drum 140. Adjacent features are omitted for clarity. Housing 120 may include a ridge guide 122 that is provided circumferentially around coupler opening 121. The ridge 143 of transfer drum 140 may be provided within ridge guide 122. In this way, the transfer drum 140 may rotate, as described above, while retaining is position within housing 120. Transfer drum 140 also may include a pin 145 for securing the transfer drum 140 to the housing 120.

It will be apparent to those skilled in the art that various modifications and variations can be made in the spool box of the present subject matter. Thus, it is intended that the present subject matter covers modifications and variations of this subject matter provided they come within the scope of the appended claims and equivalents of the appended claims.

What is claimed is:

1. A spool box comprising:
a housing;
a cord spool;
a transfer drum;
a coil spring drum; and
a coil spring,
wherein the cord spool, transfer drum, and coil spring drum are disposed at least mostly in the housing, and
wherein the spool box includes a coupling interface for coupling to a motorized converter module.

2. The spool box of claim 1, wherein the coupling interface is disposed on the transfer drum.

3. The spool box of claim 1, wherein
the coil spring has two ends,
a first end of the coil spring is attached to the coil spring drum, and
a second end of the coil spring is attached to the transfer drum.

4. The spool box of claim 1, wherein
the transfer drum includes a spur gear on one end,
the cord spool includes a spur gear on one end, and
the spur gear of the transfer drum is engaged with the spur gear of the cord spool.

5. The spool box of claim 1, wherein
the transfer spool includes a ridge,
the housing includes a ridge guide, and
the ridge is disposed within the ridge guide.

6. The spool box of claim 1, wherein the window covering comprises cellular blinds.

7. A window covering assembly comprising:
a window covering;
a header;
a spool box comprising:
a housing;
a cord spool;
a transfer drum;
a coil spring drum; and
a coil spring; and
a motorized converter module,
wherein the cord spool, transfer drum, and coil spring drum are disposed at least mostly in the housing, and
wherein the spool box includes a coupling interface for coupling to the motorized converter module, and
wherein the spool box and motorized converter module are coupled.

8. The window covering assembly of claim 7, wherein the coupling interface is disposed on the transfer drum.

9. The window covering assembly of claim 7, wherein
the coil spring has two ends,
a first end of the coil spring is attached to the coil spring drum, and
a second end of the coil spring is attached to the transfer drum.

10. The window covering assembly of claim 7, wherein
the transfer drum includes a spur gear on one end,
the cord spool includes a spur gear on one end, and
the spur gear of the transfer drum is engaged with the spur gear of the cord spool.

11. The window covering assembly of claim 7, wherein
the transfer spool includes a ridge,
the housing includes a ridge guide, and
the ridge is disposed within the ridge guide.

12. The window covering assembly of claim 7, wherein the window covering comprises cellular blinds.

13. A method comprising:
disposing a spool box in a window covering assembly, the spool box comprising:
a housing;
a cord spool;
a transfer drum;
a coil spring drum; and
a coil spring,
wherein the cord spool, transfer drum, and coil spring drum are disposed at least mostly in the housing, and
wherein the spool box includes a coupling interface for coupling to a motorized converter module;
coupling a motorized converter module that includes a motor to the spool box;
activating the motor to rotate with a torque;
transmitting the torque via a transmission to the spool box;
converting at least a portion of the torque at the spool box to raise or lower a window covering.

14. The method of claim 13 further comprising the step of:
converting a portion of the torque at the spool box to energize the coil spring.

15. The method of claim 13, wherein the step of coupling the motorized converter module to the spool box includes coupling a shaft of the motorized converter module to an interface on the transfer drum.

16. The method of claim 15, wherein the shaft is generally cylindrical with an external spline and the interface includes an internal spline.

17. The method of claim 13, wherein the step of converting at least a portion of the torque at the spool box to raise or lower a window covering includes the step of transmitting the torque through a spur gear on the transfer drum to a spur gear on the cord spool.

18. The method of claim 13, wherein the window covering comprises cellular blinds.

19. A method of raising or lowering a window covering of a window covering assembly comprising:
applying a force to the window covering to either raise or lower the window covering;
coupling a motorized converter module that includes a motor to a spool box of the window covering assembly; and
activating the motor to either raise or lower the window covering.

20. The method of claim 19, wherein the spool box is the spool box of claim 1.
